(19) United States
(12) Patent Application Publication
(10) Pub. No.: US 2004/0119578 A1
(43) Pub. Date: Jun. 24, 2004

(54) Packaging structure for an electronic element

(76) Inventor: Ching-Lung Tseng, Miao-Li Hsien (TW)

Correspondence Address: Supreme Patent Services, Post Office Box 2339, Saratoga, CA, 95070-0339, US

(21) Appl. No.: 10/327,312

(22) Filed: Dec. 20, 2002

(51) Int. Cl. H01H 85/175; H01H 85/02

(52) U.S. Cl. 337/186; 337/297

(57) ABSTRACT

A packaging structure includes an upper conductive layer adapted to completely cover an upper area of the electronic element, a first lower conductive layer adapted to cover a left portion of a bottom area of the electronic element, and a second lower conductive layer adapted to cover a right portion of a bottom area of the electronic element. An insulation layer is sandwiched between the first lower conductive layer and the second lower conductive layer. The insulation layer is adapted to cover a central portion of the bottom area of the electronic element.

### FIELD OF THE INVENTION

The present invention relates to a packaging structure, and more particularly to a packaging structure for an electronic element.

### BACKGROUND OF THE INVENTION

As the fast growth of modern technology, large quantity of electronic elements is dramatically required. These electronic elements are basically divided into two categories: one is the active element and the other is the passive element. The active element is able to proceed data operation. The passive element can only amplify or just allow the signal to pass therethrough. Normal passive elements are resistance, inductor, capacitor . . . etc. However, in order to cope with the miniaturization of modern electronic devices, surface mounting device (SMD) has been a trend in the manufacturing industry.

With reference to FIGS. 1A, 1B and 1C, a conventional electronic element has a body 40 with a top silver layer 20 applied on top of the body 40 and a bottom silver layer 30 applied on a bottom of the body 40. Two silver terminals 10 are applied to opposite ends of the body 40. Thereafter, a layer of insulation such as epoxy resin, silicone gel, glass . . .

SMD may be structurally divided into single layer and laminar layer. The feature of a SMD is focus on the terminal. Usually, a silver gel is applied to two opposite ends of an electronic element. After heating up to 600 to 800 degrees, a layer of nickel is plated on top of the silver gel to enhance the strength of the silver gel to withstand the heat in the welding process. Again, because nickel is not compatible with the solder used in the welding process, a layer of Tin is added on top of the nickel. Therefore, after completion of the manufacture of a surface mounting device, there is one problem which can not be successfully solved. That is, the welding technique used in the entire process destroys the silver gel surface and thus becomes a major concern in the industry. To overcome the problem, the thickness of the silver gel is increased to withstand the heat. However, defected products are often seen in the line of production.

To overcome the shortcomings, the present invention tends to provide an improved packaging structure for an electronic element to mitigate and obviate the aforementioned problems.

### SUMMARY OF THE INVENTION

The primary objective of the present invention is to provide an improved packaging structure for an electronic element to simplify the manufacture process and to increase reliability of the electronic element.

Other objects, advantages and novel features of the invention will become more apparent from the following detailed description when taken in conjunction with the accompanying drawings.

### BRIEF DESCRIPTION OF THE DRAWINGS

FIG. 1A is a perspective view of a conventional electronic element;

FIG. 1B is a top plan view of the electronic element in FIG. 1A;

FIG. 1C is a bottom plan view of the electronic element in FIG. 1A;

FIG. 2 is a cross sectional view of the electronic element of the first embodiment of the present invention;

FIG. 3 is a top plan view of the electronic element in FIG. 2;

FIG. 4 is a rear plan view of the electronic element in FIG. 2;

FIG. 5 is a perspective view of the electronic element of the second embodiment of the present invention;

FIG. 6A is a top plan view of the electronic element of the second embodiment in FIG. 5;

FIG. 6B is a bottom plan view of the electronic element of the second embodiment in FIG. 5;

FIG. 7A is a top plan view of the electronic element of the second embodiment in FIG. 5 with insulation layer applied over the top area of the electronic element; and

FIG. 7B is a bottom plan view of the electronic element of the second embodiment in FIG. 5 with the insulation layer applied only to the central portion of the bottom face of the electronic element.

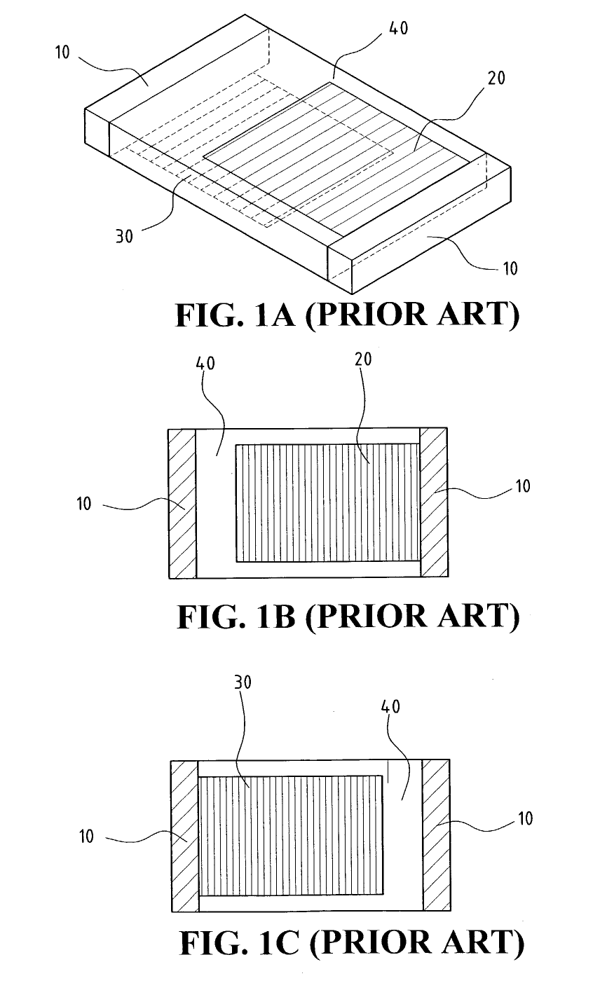

### DETAILED DESCRIPTION OF THE INVENTION

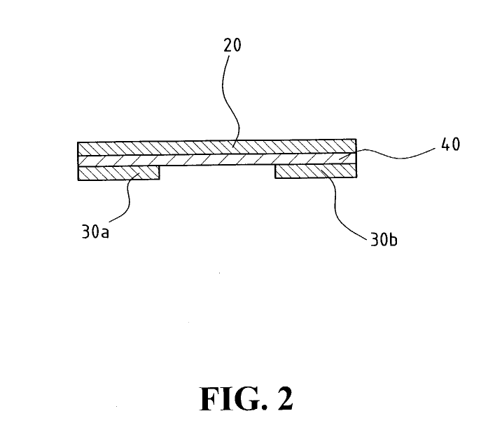

With reference to FIG. 2, a series-type structure of the present invention includes an upper conductive layer 20, lower conductive layers 30a, 30b and an electronic element 40 sandwiched between the upper conductive layer 20 and the lower conductive layers 30a, 30b. The upper conductive layer 20 covers the entire upper area of the electronic element 40. The lower conductive layers 30a, 30b cover only a portion of the lower area of the electronic element 40. With this arrangement, electrical current flows through the electronic element 40 via the lower conductive layer 30a, the upper conductive layer 20 and the lower conductive layer 30b or the lower conductive layer 30b, the upper conductive layer 20 and the lower conductive layer 30a.

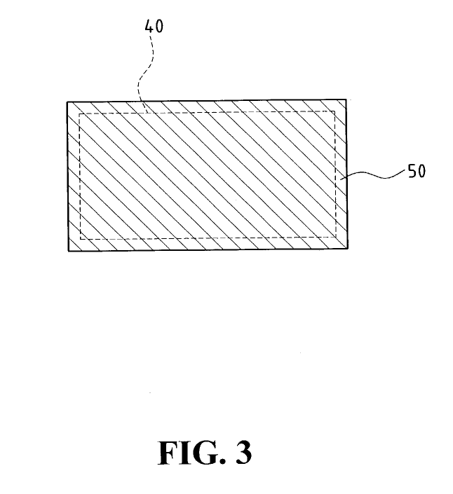

With reference to FIG. 3, it is noted from this drawing that an insulation layer 50 covers the entire area of the upper area of the electronic element 40.

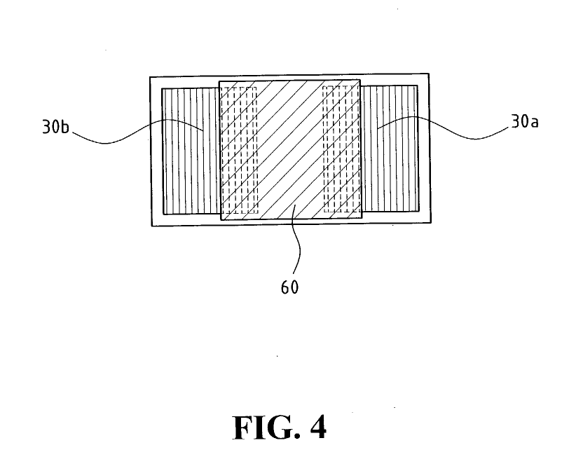

With reference to FIG. 4, it is noted that the lower conductive layers 30a, 30b respectively cover the right and the left areas of the bottom area of the electronic element 40. A second insulation layer 60 covers the area sandwiched between the right and the left areas of the bottom area of the electronic element 40.

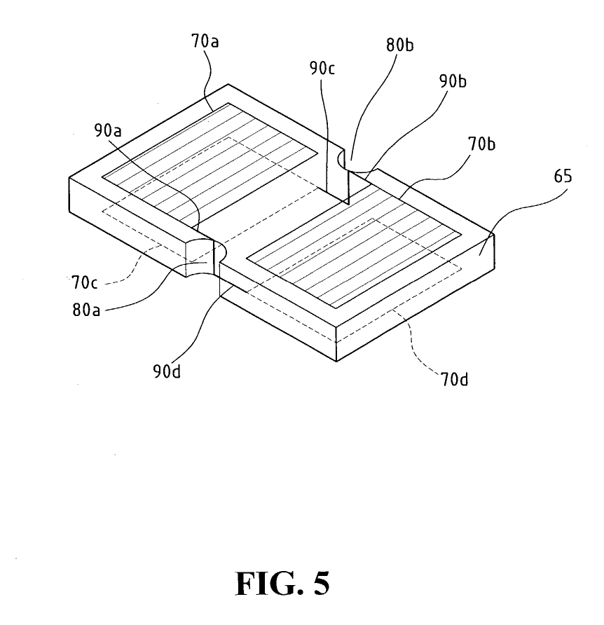

With reference to FIG. 5, a parallel-type structure of the present invention is shown and includes an electronic element 65, an upper left conductive layer 70a, an upper right conductive layer 70b, a lower left conductive layer 70c and a lower right conductive layer 70d. At least one passage (two passages 80a, 80b are shown in this embodiment) is defined to extend through upper face and lower face of the structure. The upper left conductive layer 70a, the upper right conductive layer 70b, the lower left conductive layer 70c and the lower right conductive layer 70d respectively extends toward the passage a first wire 90a, a second wire 90b, a third wire 90c and a fourth wire 90d.

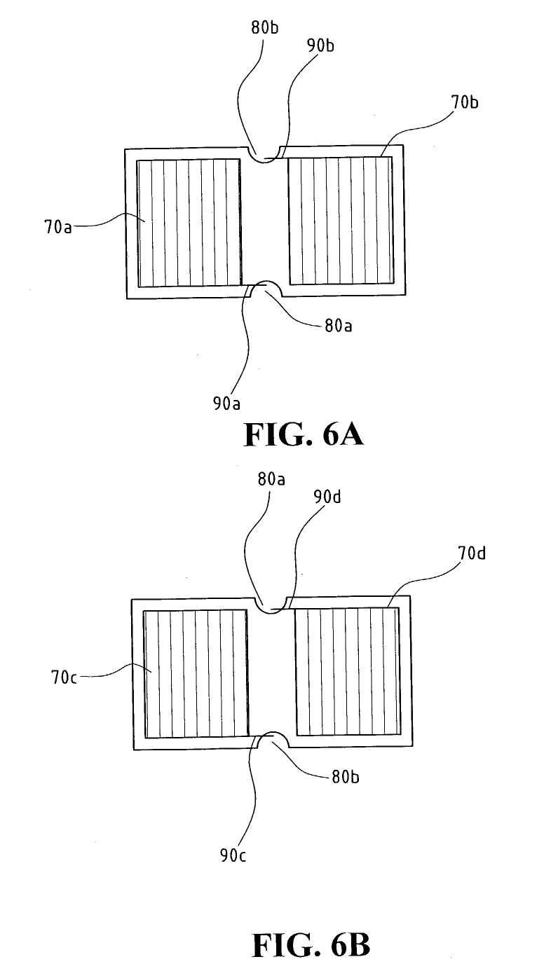

With reference to FIGS. 6A and 6B, it is noted that the upper left conductive layer 70a and the upper right conductive layer 70b cover only a portion of an upper area of the electronic element 65, namely the right portion and the left portion of the upper area of the electronic element 65. The lower left conductive layer 70c and the lower right conductive layer 70d cover only a portion of a bottom area of the electronic element 65, namely the left portion and the right portion of the bottom area of the electronic element 65. The first wire 90a extends through the passage 80a and connects to the fourth wire 90d. The second wire 90b extends through the passage 80b and connects to the third wire 90c. With this arrangement, the electrical current flowing through the electronic element 65 via the upper left conductive layer 70a, the upper right conductive layer 70b, the lower left conductive layer 70c and the lower right conductive layer 70d respectively.

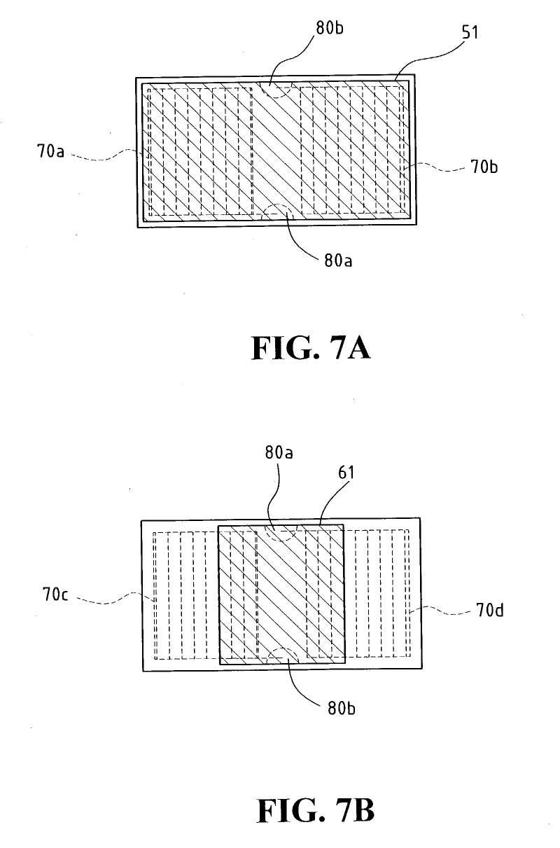

With reference to FIG. 7A, an insulation layer 51 covers the upper area of the packaging structure and a large portion of the passages 80a, 80b.

With reference to FIG. 7B, a second insulation layer 61 covers a central portion of the bottom area of the packaging structure and a portion of the lower left conductive layer 70c and the lower right conductive layer 70d. The second insulation layer 61 covers a large portion of the passages 80a, 80b.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A packaging structure for an electronic element, the packaging structure comprising:
an upper conductive layer adapted to completely cover an upper area of the electronic element;
a first lower conductive layer adapted to cover a left portion of a bottom area of the electronic element;
a second lower conductive layer adapted to cover a right portion of a bottom area of the electronic element; and
an insulation layer sandwiched between the first lower conductive layer and the second lower conductive layer, the insulation layer adapted to cover a central portion of the bottom area of the electronic element.

2. The packaging structure as claimed in claim 1, wherein the upper conductive layer, the lower first conductive layer and the second lower conductive layer are made of conductive materials.

3. The packaging structure as claimed in claim 1, further comprising a second insulation layer covering an upper area of the electronic element.

4. A packaging structure for an electronic element, the packaging structure comprising:
an upper left conductive layer adapted to cover a left portion of an upper area of the electronic element;
an upper right conductive layer adapted to cover a right portion of the upper area of the electronic element;
a lower left conductive layer adapted to cover a left portion of a bottom area of the electronic element;
a lower right conductive layer adapted to cover a right portion of the bottom area of the electronic element;
a first passage and a second passages adapted to be defined in opposite sides of the electronic element to extend through an upper face and a lower face of the opposite sides of the electronic element;
wherein the upper left conductive layer, the upper right conductive layer, the lower left conductive layer and the lower right conductive layer respectively extends toward the passage a first wire, a second wire, a third wire and a fourth wire, and
the first wire extends through the first passage and connects to the fourth wire, the second wire extends through the second passage and connects to the third wire; and
a first insulation layer sandwiched between the lower left conductive layer and the lower right conductive layer, the first insulation layer adapted to cover a central portion of the bottom area of the electronic element.

5. The packaging structure as claimed in claim 4, wherein the upper left conductive layer, the upper right conductive layers, the lower left conductive layer and the lower right conductive layer are made of conductive materials.

6. The packaging structure as claimed in claim 5, further comprising a second insulation layer adapted to cover an upper area of the electronic element.
